(19) United States
(12) Patent Application Publication
(10) Pub. No.: US 2011/0143037 A1
(43) Pub. Date: Jun. 16, 2011

(54) High-Speed Wire Coating Device and Method

(75) Inventors: Henri Hinc, Romagnat (FR); Guy Chevrel, Lezoux (FR)

(73) Assignee: SOCIETE DE TECHNOLOGIE MICHELIN, Clermont-Ferrand (FR)

(21) Appl. No.: 12/995,446

(22) PCT Filed: May 27, 2009
(86) PCT No.: PCT/EP09/56466

§ 371 Date: Feb. 23, 2011

(30) Foreign Application Priority Data
May 30, 2008 (FR) 08/53572

(51) Int. Cl. B05D 3/10; B05C 13/02

(52) U.S. Cl. 427/333; 118/56

(57) ABSTRACT

Device for continuously depositing a treatment substance (20) on the surface of a thread (10), comprising: impregnation means (2) for impregnating the thread by dipping it into a bath designed to contain a solution of the treatment substance (20) in liquid form, through which bath the thread (10) runs when the device is in operation; draining means (3), placed downstream of the impregnation means (2), capable of removing the excess liquid (22) entrained by the thread; treatment means (4) placed downstream of the draining means (3), capable of making the liquid solution remaining on the thread solidify; and means (51, 52, 53, 54) suitable for guiding and running the thread (10) from the inlet to the outlet of the device along a direction d_{f} and at a speed V_{f}, wherein the draining means (3) include means capable of spraying said treatment liquid with an appropriately regulated velocity Vⱼ towards the thread (10) in the form of jets (21) that converge in directions dⱼ making an obtuse angle α with the direction d_{f} in which said thread (10) runs, so as to adjust the thickness e of liquid remaining on the thread (10) on leaving said draining means (3).

The invention relates to the field of manufacturing cords and threads and more particularly to the step during which a treatment is carried out on these threads.

In many processes, it proves useful to deposit a layer of controlled thickness of a given substance on the surface of the thread so that, in a subsequent manufacturing step, the thread can be processed more easily.

This is the case for example when it is desired to use the thread as a fibre for reinforcing a plastic. It is then necessary to treat the thread so as to make it adhere perfectly to the matrix of the material in question, by depositing a coupling substance on the surface of the thread so as to make the cooperation between these two components as effective as possible. This type of application is widely used in the tire industry or in the reinforced plastics industry.

In the context of the present description, the term “thread” should be understood in a very general sense, covering a monofilament, a multifilament, a cabled or folded yarn or an equivalent assemblage, whatever the material, textile or metallic, of which the thread is made.

More particularly, the invention relates to treatments in which, during a first step, a thin film of a treatment substance is deposited on the surface of the thread in liquid form. This treatment substance may for example be formed from a solvent and an active solute, or else from a substance capable of curing.

The purpose of the following treatment step is to extract the solvent so as to leave on the surface of the thread only the active substance or to allow the curing reaction to be completed, or else to carry out a combination of these two actions.

Very particular attention must therefore be paid to the precise amount of liquid present on the surface of the thread. It is in fact important to ensure that the liquid film deposited, which generally has a small thickness, is as uniform as possible in order to ensure that the properties of the thread are uniform over its entire length.

For this purpose, the known techniques of wetting or coating consist in making the thread run through a bath containing the treatment liquid that it is desired to deposit. By dipping the thread into the bath, it is impregnated with the liquid solution and then emerges therefrom, going towards the treatment step during which the drying or curing takes place.

However, it has been observed that, depending on the nature of the thread or the liquid to be deposited, the thread could behave as a veritable pump, capable of entraining therewith an amount of liquid much greater than the necessary amount. This pumping effect is associated with parameters such as the viscosity of the liquid, the difference in surface tension between the thread and the treatment substance in liquid form, and the run speed of the thread through the bath.

This is why it is recommended to use one or more sets of scrapers or wipers, placed at the outlet of the dipping bath and capable of extracting the superfluous amount of liquid. However, these means may prove to be limited in so far as they are themselves liable to become blocked owing to the many contacts existing between the thread and the draining means, thereby limiting their capability of fulfilling their function, in particular when, for obvious productivity reasons, it is desired to increase the run speed of the thread. The object of the invention is to provide a solution to this problem. Such a device is described by way of example in the publication DE 43 08 889.

The device according to the invention for continuously depositing a treatment substance on the surface of a thread comprises:
impregnation means for impregnating the thread by dipping it into a bath designed to contain a solution of the treatment substance in liquid form, through which bath the thread runs when the device is in operation;
draining means, placed downstream of the impregnation means, capable of removing the excess liquid entrained by the thread;
treatment means placed downstream of the draining means, capable of making the liquid solution remaining on the thread solidify; and
means suitable for guiding and running the thread from the inlet to the outlet of the device along a direction d_{f} and at a speed V_{f}.

This device is characterized in that the draining means include means capable of spraying said treatment liquid with an appropriately regulated velocity Vⱼ towards the thread in the form of jets that converge in directions dⱼ making an obtuse angle α with the direction d_{f} in which said thread runs, so as to adjust the thickness e of liquid remaining on the thread on leaving said draining means.

The jets therefore spray the liquid onto the thread with a velocity having one component which is parallel to the thread but in the opposite direction to that in which the thread advances, this having the effect of wiping off the excess liquid entrained by the thread.

By judiciously adjusting the speed of the thread or the velocity and the spray rate of the liquid, it is then possible for the amount of treatment liquid deposited per unit length of thread leaving the device to be precisely regulated.

It should also be noted that the thread runs through the draining means without coming into contact with said means. It follows that, advantageously, it is possible to run the thread through the treatment device between the outlet of the impregnation means and the outlet of the processing means without said thread coming into contact with the guiding means. This advantage may prove to be decisive for regulating the amount of treatment substance on the thread without this amount being altered by the thread rubbing on a pulley or a capstan.

It is also possible to vary the spray angle of the jets so as to obtain a similar effect. However, it turns out that an angle which is too low or close to 180° does not allow the liquid to effectively wipe the surface of the thread, while too high an angle, close to 90°, forces the “pumping” of the liquid by the thread to increase. It has thus been found that an angle between 120° and 160° gives good results.

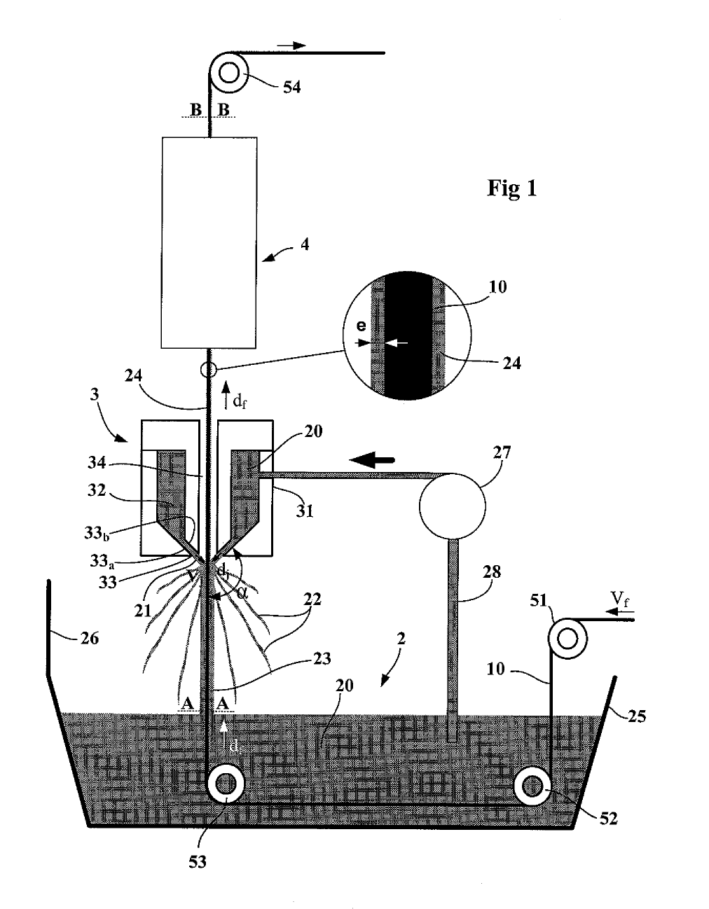

The purpose of the following description is to explain the characteristic principles of the invention, based on FIG. 1 that shows a schematic view of a device according to the invention in the operating condition.

The device serving as the basis for the present description comprises impregnation means 2, draining means 3, treatment means and means formed by turn pulleys, capable of making a thread 10 run, from the inlet (51) to the outlet (54) of the device, between and through the impregnation means (52, 53).

The impregnation means 2 are for example formed by a tank 25 containing a treatment liquid 20. This treatment liquid may be a solute diluted in a solvent or else an organic compound capable of curing under the action of heat or an energy source, such as laser or UV radiation.

The continuous thread 10 is driven through the tank 25 by drive means (not shown) such as a motorized pulley, from a thread source (not shown). The thread moves through the treatment device at a speed V_{f}. On leaving the device the thread may be repackaged for the purpose of a subsequent production step, or integrated directly into the material to be reinforced.

On leaving the treatment bath 2, the thread 10 is impregnated with the treatment liquid 20, which also forms a film 23 over the entire surface of the thread. As has already been mentioned above, it has been observed that the thread acts as a pump and that the amount of treatment liquid 23 entrained by the thread increases when the run speed V_{f} increases. Thus, when it is desired to increase the speed V_{f} for obvious productivity reasons, the amount of liquid deposited on the thread increases, and it is absolutely necessary to regulate the liquid thickness e (see inset).

The draining means are formed by a central channel 34 through which the thread 10 runs at the speed V_{f} in a direction d_{f} corresponding approximately to the longitudinal direction of the channel 34. The draining means 3 may advantageously be oriented so that the run direction d_{f} of the thread is directed vertically upwards.

The draining means 3 also include an inlet 31 via which the pressurized treatment liquid 20 enters a chamber 32. The treatment liquid is expelled by nozzles 33 in the form of jets 21 which converge on the thread 10 with the velocity Vⱼ. The jets are oriented so that the spray direction dⱼ of liquid onto the thread makes an obtuse angle α with the run direction d_{f} of the thread.

The collision of the jets 21 on the surface of the thread 10 has the effect of ejecting the excess liquid in the form of splashes 22, which can be recovered in a container of suitable shape. For this purpose, and by way of illustration, the wall 26 of the tank 25 may be raised to ensure that this excess treatment liquid falls into the tank 25 under gravity.

A recirculation pump 27 draws up the treatment liquid via a duct 28 so as to supply the pressurized chamber 32.

Thus, for a thread speed V_{f}, the velocity Vⱼ and the output flow rate of the jets 21 of the treatment liquid are adjusted by varying the flow rate and the output pressure of the pump 27 so as to obtain a liquid thickness e deposited on the thread which is constant on leaving the draining means 3. This regulating means makes it possible, among other things, to circumvent any irregularity due to the transient phases or to the variations in speed imposed by the speed of the thread by a process located upstream or downstream of the treatment device forming the subject matter of the present invention.

Finally, it is also possible to modify the angle α. Increasing the angle α has the effect of reducing the liquid thickness e entrained by the thread. However, this regulating means proves to be more difficult to implement. Consequently, it is preferred to determine an angle between the rows given above and to vary the run speed V_{f} or the ejection velocity Vⱼ simultaneously or separately in order to regulate the liquid thickness deposited on the thread.

In order for the system to be effective, it is advantageous to make the jets converge precisely on the thread and to ensure that the sum of the components perpendicular to the direction of the thread of the vectors, representing the momentum of each of the jets, is approximately equal to zero so as not to induce forces perpendicular to the thread that could shift it towards the walls of the channel 34.

In practice, assuming that the ejection velocities and the flow rates of each of the nozzles are the same, measures are taken to ensure that the components perpendicular to the run direction of the thread of the velocity vector V_{f} of each of the jets have approximately equal moduli and that the jets are placed around the central channel 34 so that these vector values cancel out. This amounts to placing the nozzles at the vertices of a regular polygon lying in a plane perpendicular to the direction d_{f}, the centre of the polygon corresponding to the point through which the thread passes.

By extension, it is thus possible to design a circular nozzle, the internal walls 33ₐ, 33_{b} of which take the form of nested cone frustums, the axis of which corresponding approximately to the axis of the channel 34, and a generatrices of which make an external angle equal to the angle α.

These draining means have the particular benefit of being able to be simply regulated according to the run speed V_{f} of the thread, unlike the conventional draining means such as wiping rollers that have the drawback of becoming saturated when the amount of excess liquid to be removed becomes too great.

The matching of the spray velocities and flow rates to the run speed of the thread must be accomplished within the limits imposed by the nature and the physical characteristics of the thread and of the liquid to be sprayed, the main descriptors of which are the viscosity, the wettability and the surface finish of the thread.

Placed downstream of the draining means 3 are the treatment means 4, these having the purpose of fixing the treatment liquid and of making said liquid pass from the liquid phase to the solid or plastic phase. These means may, as an example, comprise heating means for evaporating the solvent of the treatment liquid or initiating a curing reaction, which will set the treatment product on the surface of the thread 10. This reaction may be produced by other means, such as induction heating means, UV radiation or laser radiation, or any other means capable of making the treatment substances contained in the treatment liquid adhere to the surface of the thread.

One of the advantageous features of the device according to the invention is that it is possible to make the thread run from the outlet of the impregnation means 2, indicated by the line AA, to the outlet of the treatment means 4, indicated by the line BB, without the thread coming into contact with the walls of the channel 34, or with a turn pulley belonging to the guiding system. The thread runs freely between the turn pulleys 53 and 54. This advantageously eliminates all the causes liable to alter the form of the film of treatment liquid until the latter has finally solidified on leaving the treatment means 4.

1. A device for continuously depositing a treatment substance on the surface of a thread, comprising:
impregnation means for impregnating the thread by dipping it into a bath designed to contain a solution of the treatment substance in liquid form, through which bath the thread runs when the device is in operation;
draining means, placed downstream of the impregnation means, capable of removing the excess liquid entrained by the thread;
treatment means placed downstream of the draining means, capable of making the liquid solution remaining on the thread solidify; and
means suitable for guiding and running the thread from the inlet to the outlet of the device along a direction d_{f} and at a speed V_{f},
wherein the draining means include means capable of spraying said treatment liquid with an appropriately regulated velocity Vⱼ towards the thread in the form of jets that converge in directions dⱼ making an obtuse angle α with the direction d_{f} in which said thread runs, so as to adjust the thickness e of liquid remaining on the thread on leaving said draining means.

2. The device according to claim 1, wherein a straight channel passes right through the draining means, the thread running through said channel when the device is in operation.

3. The device according to claim 2, wherein when the device is in operation, the thread runs through the draining means without coming into contact with the walls of said channel of said draining means.

4. The device according to claim 3, wherein when said device is in operation, the thread runs between the outlet of the impregnation means and the outlet of the treatment means without coming into contact with the guiding means.

5. The device according to claim 2, wherein the draining means comprise a single circular nozzle, the internal walls of which take the form of nested cone frustrums, the axis of which corresponds approximately to the axis of the channel and the generatrices of which make an external angle approximately equal to the angle α.

6. The device according to claim 1, wherein the angle α of spraying of the liquid is between 120° and 160° C.

7. The device according to claim 1, further comprising means capable of regulating the liquid spray velocity Vj according to the run speed Vf of the thread and to the desired liquid thickness e on leaving said draining means.

8. The device according to claim 7, further comprising means capable of adjusting the flow rate and the pressure of the treatment liquid sprayed onto the thread.

9. The device according to claim 1, further comprising means for capturing and for recirculating the liquid sprayed onto the surface of the thread by the draining means.

10. A thread treatment method comprising the steps of:
impregnating a thread by making it run, in a direction d_{f} and at a given speed V_{f}, through a bath containing a treatment substance in liquid form;
draining the thread so as to remove the excess liquid entrained by the thread; and
solidifying the liquid remaining on the thread, so that the treatment substance adheres to the thread,
wherein the thread is drained in a draining means by spraying said treatment substance at an appropriately regulated velocity Vⱼ towards the thread in the form of jets that converge in directions dⱼ making an obtuse angle α with the direction d_{f} in which said thread runs.

11. The treatment method according to claim 10, wherein the spray velocity Vⱼ and the flow rate of the jets are regulated according to the run speed V_{f} of the thread and the desired liquid thickness e on leaving the draining means.

12. The method according to claim 10, wherein the jets have flow rates and ejection velocities Vⱼ that are approximately equivalent.
